(19) United States
(12) Patent Application Publication
(10) Pub. No.: US 2026/0352726 A1
(43) Pub. Date: Nov. 5, 2026

(54) CONTENT TRANSFER BETWEEN INTERFACES

(71) Applicant: Arm Limited, Cambridge (GB)

(72) Inventors: Madhusudan Dhanamatnahalli RAMASWAMY, Bangalore (IN); Alex James Waugh, Cambridge (GB)

(21) Appl. No.: 19/198,215

(22) Filed: May 5, 2025

(51) Int. Cl. H04L 67/06

(52) U.S. Cl. CPC H04L 67/06

(57) ABSTRACT

There is provided an apparatus comprising a requestor interface to couple a requestor device to the apparatus, and a completer interface to couple the apparatus to a completer device. The apparatus is provided with a transport layer to transfer content between the requestor interface and the completer interface according to a protocol that enables the transfer of content to be completed in a completion order other than a request order. The requestor interface is responsive to receipt of a plurality of ordered requests specifying content to be retrieved in a prescribed order, to issue a plurality of requests to the completer interface, the plurality of requests comprising one or more deferred-return requests for content. The completer interface is responsive to a deferred-return request to retrieve the content and to defer returning the content until a content return request specifying the content is received.

### TECHNICAL FIELD

The present invention relates to data processing. More particularly the present invention relates to an apparatus, a system, a chip-containing product, a method, and a computer-readable medium.

### BACKGROUND

Some apparatuses are configured to couple to requestor devices, for example, via a requestor interface, and to a completer device, for example, via a completer interface. Requests may be transferred between the requestor interface and the completer interface.

### SUMMARY

According to a first aspect of the present techniques there is provided an apparatus comprising:
a requestor interface configured to couple a requestor device to the apparatus;
a completer interface configured to couple the apparatus to a completer device;
a transport layer configured to transfer content between the requestor interface and the completer interface according to a transport protocol that enables the transfer of content to be completed in a completion order other than a request order in which the transfer of content was requested,
wherein the requestor interface is responsive to receipt of a plurality of ordered requests specifying content to be retrieved in a prescribed order, to issue a plurality of requests to the completer interface via the transport layer, the plurality of requests comprising one or more deferred-return requests for corresponding content specified in the plurality of ordered requests, wherein the completer interface is responsive to a deferred-return request of the one or more deferred-return requests to retrieve the corresponding content specified in the deferred-return request and to defer returning the corresponding content to the requestor interface until a corresponding content return request specifying the corresponding content is received from the requestor interface.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method of operating an apparatus comprising a requestor interface configured to couple a requestor device to the apparatus, and a completer interface configured to couple the apparatus to a completer device, the method comprising:
with a transport layer, transferring content between the requestor interface and the completer interface according to a transport protocol that enables the transfer of content to be completed in a completion order other than a request order in which the transfer of content was requested,
in response to receipt, at the requestor interface, of a plurality of ordered requests specifying content to be retrieved in a prescribed order, issuing a plurality of requests to the completer interface via the transport layer, the plurality of requests comprising one or more deferred-return requests for corresponding content specified in the plurality of ordered requests;
   in response to a deferred-return request of the one or more deferred-return requests, with the completer interface, retrieving the corresponding content specified in the subsequent request and deferring returning the corresponding content to the requestor interface until a content return request specifying the corresponding content is received from the requestor interface.

According to a fifth aspect of the present techniques there is provided a non-transitory computer-readable medium storing computer-readable code for fabrication of an apparatus comprising:
a requestor interface configured to couple a requestor device to the apparatus;
a completer interface configured to couple the apparatus to a completer device;
a transport layer configured to transfer content between the requestor interface and the completer interface according to a transport protocol that enables the transfer of content to be completed in a completion order other than a request order in which the transfer of content was requested,
wherein the requestor interface is responsive to receipt of a plurality of ordered requests specifying content to be retrieved in a prescribed order, to issue a plurality of requests to the completer interface via the transport layer, the plurality of requests comprising one or more deferred-return requests for corresponding content specified in the plurality of ordered requests, wherein the completer interface is responsive to a deferred-return request of the one or more deferred-return requests to retrieve the corresponding content specified in the deferred-return request and to defer returning the corresponding content to the requestor interface until a corresponding content return request specifying the corresponding content is received from the requestor interface.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3a schematically illustrates an example of a request of a first type according to some configurations of the present techniques;

FIG. 3b schematically illustrates an example of a request of a second type according to some configurations of the present techniques;

FIG. 4 schematically illustrates an example of a first request and a second request;

FIG. 5 schematically illustrates an example of a first request and a second request according to some configurations of the present techniques;

FIG. 6 schematically illustrates an apparatus according to some configurations of the present techniques;

FIG. 7 schematically illustrates a sequence of steps according to some configurations of the present techniques;

FIG. 8 schematically illustrates a sequence of steps according to some configurations of the present techniques;

FIG. 9 schematically illustrates a sequence of steps according to some configurations of the present techniques;

FIG. 10 schematically illustrates a sequence of steps according to some configurations of the present techniques; and

FIG. 11 schematically illustrates a system and a chip-containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising a requestor interface configured to couple a requestor device to the apparatus. The apparatus comprises a completer interface configured to couple the apparatus to a completer device. The apparatus comprises a transport layer configured to transfer content between the requestor interface and the completer interface according to a transport protocol that enables the transfer of content to be completed in a completion order other than a request order in which the transfer of content was requested. The requestor interface is responsive to receipt of a plurality of ordered requests specifying content to be retrieved in a prescribed order, to issue a plurality of requests to the completer interface via the transport layer, the plurality of requests comprising one or more deferred-return requests for corresponding content specified in the plurality of ordered requests. The completer interface is responsive to a deferred-return request of the one or more deferred-return requests to retrieve the corresponding content specified in the deferred-return request and to defer returning the corresponding content to the requestor interface until a corresponding content return request specifying the corresponding content is received from the requestor interface.

In some systems an apparatus may be provided to couple requestor devices to completer devices. The apparatus may be provided with one or more requestor interfaces, each configured to couple to a respective requestor device, and one or more completer devices, each configured to couple to a respective completer device. A requestor device may be a processing circuit, for example, a processing core having a processing pipeline, a hardware accelerator, and/or a further device, e.g., an off chip device, to be coupled to the completer devices associated with the apparatus. A completer device may be, for example, storage circuitry external to the apparatus or local storage internal to the apparatus.

Communication between the requestor interface and the completer interface is provided by a transport layer that is configured to route requests and content (e.g., data and/or instructions) between the requestor interface and the completer interface. Transfer of information through the transport layer is carried out according to a transport protocol which may, for example, specify a format, and/or a route taken by content and requests being transferred. The transport protocol is configured such that there are no strict ordering requirements placed on the content being transferred. For example, if two content items are transferred between the completer interface and the requester interface, the transport protocol does not guarantee that a first content item, transferred sequentially before a second content item, will reach the requestor interface before the second content item. To put this another way, the protocol permits a content item that is being transferred between the requestor interface and the completer interface to overtake a further content item already being transferred between the requestor interface and the completer interface. For example, if transfer of a relatively small content item begins whilst a relatively large content item is being transferred, the relatively small content item may be transferred in its entirety before transfer of the relatively large content item is completed.

In some use cases, there is a need to couple a variety of different types of requestor devices and completer devices to the apparatus and some requestor devices and/or completer devices may require that content, that is transferred in response to a set of requests, is delivered in a prescribed order, for example, an explicitly defined order or the order in which the requestor interface received requests from the requestor device. The prescribed ordering could theoretically be enforced by queuing requests at the requestor interface and servicing each of the requests in sequence, i.e., such that a first request is transmitted from the requestor interface to the completer interface and a second, subsequent, request is stalled at the requestor interface until content specified in the first request has been returned to the requestor interface. Whilst this approach enforces ordering, there can be an increased latency associated with this because, for each request, the request has to be transferred to the completer interface, and the completer interface retrieves the data. Subsequently, the retrieved content is transferred to the requestor interface before a next request can be issued. As a result, the latencies associated with each step occur in sequence. An alternative mechanism that could, theoretically, enforce ordering would be to incorporate a reorder buffer at the requestor interface. The requestor interface could therefore receive requested content in any order which could then be buffered and returned to the requestor device in the prescribed order. This approach could reduce the latency as multiple ones of the requests received at the requestor interface could be issued to the completer interface and, subsequently, to the completer device before content for a preceding request is returned. However, the addition of a reorder buffer at the requestor interface would require a large circuit area increasing the circuit footprint and power consumption of the apparatus.

The inventors have recognised that a reduction in latency can be achieved without implementing a reorder buffer by requesting the content using deferred-return requests that are issued from the requestor interface to the completer interface. The completer interface is responsive to the deferred return requests to retrieve the corresponding content specified in the deferred-return requests and to hold that corresponding content at the completer interface. The corresponding content is not returned until a content return request specifying the corresponding content is received from the requestor interface. In other words, the deferred-return requests cause the corresponding content to be retrieved to the completer interface, but the subsequent transfer of that corresponding content back to the requestor interface is delayed (deferred) until the content return request for the corresponding content is received. This approach means that latency associated with retrieving content from a completer device in response to the deferred-return request can occur at least partially in parallel with latencies associated with retrieving content in response to one or more preceding requests.

In some configurations the requestor interface is configured to defer issuing the corresponding content return request until all content associated with a sequentially preceding request has been received at the requestor interface. In other words, for a given one of the deferred-content requests (i.e., request i where i is an integer identifying a given one of the plurality of ordered requests), the requestor interface is configured to defer issuing the content return requests for request i until all content has been returned for request i−1.

Whilst the requestor interface may, in some configurations, issue the plurality of requests sequentially and without deferring any of the requests, in some configurations the completer interface is responsive to receipt of each of the plurality of requests to issue an acknowledgement to the requestor interface via the transport layer; and the requestor interface is configured to defer issuing the deferred-return request until receipt of the acknowledgement for the sequentially preceding request. The use of the acknowledgements enables the requestor interface to be sure that the requests are received at the completer interface in the prescribed order. For completer devices which fulfil requests in order, this ensures that the completer device will receive the requests in the prescribed order increasing the likelihood that content will be ready to be returned by the completer interface in the prescribed order and will reduce any potential delays associated with content being returned to the completer interface in an order other than the prescribed order.

In some configurations the completer interface is configured to issue a data retrieved indication to the requestor interface once the corresponding content has been retrieved; and the requestor interface is configured to defer issuing the content return request until the data retrieved indication is received. In such configurations, the tracking of which requests have been fulfilled is handled by the requestor interface. The completer interface will not receive any content return requests for content that has not yet been returned and, hence, does not need to be provisioned with buffer circuitry to store content return requests for content that has not yet been retrieved.

In some configurations the apparatus is provided with storage circuitry accessible to the completer interface and configured to store the corresponding content retrieved in response to the deferred-return request. The storage circuitry is provided to store content retrieved in response to the plurality of requests and in response to requests received at further requestor interfaces. For example, the storage circuitry may be a storage circuit already present in the apparatus for storing content closer to the requestor devices.

In some configurations the storage circuitry is a cache. The cache may be arranged as a set associative cache or an indexed cache. The cache may be provided as a system cache accessible to a plurality of requestor devices via a respective requestor interface and the transport layer.

In some configurations the completer interface is configured to retrieve the corresponding content by performing a lookup in the storage circuitry. Where the corresponding content is present in the storage circuitry, i.e., the lookup results in a hit, the completer interface is able to issue the data retrieved indication without waiting for content to be retrieved from a further level of storage and can return the corresponding content on receipt of the corresponding content return request.

In some configurations the completer interface is responsive to the lookup resulting in a miss in the storage circuitry, to forward the deferred-return request to a further storage structure. The content may be retrieved into the storage circuitry from the further storage device, e.g., a main memory or a cache associated with a further requestor device, to be stored either in addition to being returned to the requestor device, or in anticipation of a corresponding content return request from the requestor device.

In some configurations content transfer between the requestor device and the requestor interface is performed according to a first content transfer protocol different from the transport protocol. For example, the first data transfer protocol may be an ACE based protocol, for example, the ACE-Lite protocol developed by Arm Limited, whilst the transport protocol may be an CHI based protocol developed by Arm Limited.

Whilst the transport protocol does not enforce ordering of requests, in some configurations the first content transfer protocol enforces ordering between at least some requests. In such configurations the use of the first and second types of requests enables the ordering requirements of the first data transfer protocol to be enforced.

In addition, or as an alternative, in some configurations content transfer between the completer and the completer interface is performed according to a second content transfer protocol different from the first content transfer protocol. The ordering enforced through the use of the deferred-return requests allows ordering to be enforced across the apparatus independent of the particular protocols used on the requestor side and the completer side.

In some configurations the second content transfer protocol allows at least some requests to be completed out of order with respect to an order in which the requests were received. For example, one or more further types of request may be provided to trigger retrieval of data according to the second data transfer protocol to be completed in order and one or more further types of request may be provided to trigger the retrieval of data according to the second data transfer protocol out of order. The retrieval of data by the completer interface in order helps reduce the overall latency associated with the plurality of requests which could occur if a request becomes stuck (e.g., awaiting resources) behind a further request that is behind the request in the prescribed order.

In some configurations the second content transfer protocol enforces ordering between requests identified with a same identifier. For example, requests may be issued with an identifier, e.g., an identifier of a particular process or transaction (e.g., a transaction comprising plural requests). Requests having a common identifier are serviced in order with respect to one another whilst requests, e.g., requests received from a different requestor, or associated with a different transaction from the same requestor, may be serviced out of order with respect to those having the common identifier.

In some configurations the requestor interface is configured to issue each of the plurality of requests specifying an order indicator; and the completer interface is responsive to the plurality of requests specifying the order indicator to enforce ordering between the plurality of requests. The order indicator ensures that the transactions specifying a same identifier are kept in order at the completer interface. Each request from the requestor interface is sent with the order indicator and the request identifier. The completer interface is responsive to a received request to determine if the received request has the order bit set and, if so, to issue a read receipt (acknowledgement). When a second, or subsequent, request arrives at the requester interface its AXI-ID (identifier) is compared against the outstanding requests sent to the completer interface. If the identifier matches with the existing transactions, then it is stalled until the read receipt of the preceding request is received from the completer interface. Once the read receipt has been received, the second transaction is sent to the completer interface with the order indicator set to ensure that the transaction is kept in order with respect to transactions having the same identifier, e.g., the preceding transaction, at the completer interface. Because the returned data may be received out of order at requestor interface due to the transport layer the second request is issued as a deferred-return request. In some configurations the order indicator is an order bit taking a first value when ordering is to be enforced at the completer interface and a second value different to the first value when ordering is not required at the completer interface.

In some configurations the requestor interface is responsive to receipt of a plurality of requests specifying content to be retrieved to determine whether the plurality of requests is to be retrieved in the prescribed order in dependence on whether the plurality of requests specify a same identifier. For example, the requestor interface may maintain a record of identifiers associated with outstanding requests and, when a request is received, a lookup may be performed to determine if an identifier associated with the request is stored in the record. If the identifier is recorded as being associated with an outstanding request, then the record is updated and the request is issued as a deferred-return request in a plurality of ordered requests with the order indicator set. If the identifier is not recorded as being associated with an outstanding request, then the record is updated and the request may be issued as a standard request, i.e., without requiring that the return of content is deferred and with the order indicator set. In this case the request may be either a single request having that identifier or a first request in a plurality of ordered requests. Whilst the request may be issued as a standard request (i.e., without deferred return), in some configurations the request may be issued as a deferred-return request and may be marked as a first request of a sequence of ordered requests. Subsequently, a content return request corresponding to that first request can be issued on receipt of a data retrieved indication associated with that first request, i.e., without having to wait for content associated with a previous request.

In some configurations the requestor interface comprises request tracking circuitry to track a plurality of outstanding requests; and the requestor interface is responsive to an indication that a number of outstanding requests exceeds a predefined limit, to trigger the requestor to stall incoming requests. The tracking circuitry may track a variety of details relating to the outstanding requests. For example, the tracking circuitry may track request identifiers associated with outstanding requests, along with request details, such as a content address, of content to be retrieved in the request. Furthermore, the request tracking circuitry may track additional metadata such as whether a request is a deferred-return request, whether content associated with the request has been returned, whether a request acknowledgement has been received, whether a content return request has been issued, whether a data retrieved indication has been received, etc. The request tracking circuitry may be capable of tracking a large number of outstanding requests, i.e., the predefined limit which may be, for example 128 outstanding requests or 256 outstanding requests. The request tracking circuitry is responsive to the number of outstanding requests exceeding the predefined limit to trigger the requestor to stall incoming requests, e.g., a stall signal may be issued to the requestor device to indicate that the limit has been reached. Alternatively, an acknowledgement for a request from the requestor may be deferred until there is space in the requestor tracking interface. The requestor may interpret the absence of the acknowledgement as the trigger to cease requesting further content until the acknowledgement is received.

Whilst, in some configurations, each request may be for a same sized amount of content with the requestor breaking the requests down into same sized chunks, in some configurations the completer interface is responsive to given content associated with a given one of the plurality of ordered requests exceeding a predefined size, to return the content as a plurality of content blocks of the predefined size. For example, the predefined size may be a cache line size and the requestor interface may interpret a request for an amount of content greater than a cache line size to service the request using a plurality of requests with each request being a request for a cache line. Furthermore, where a request is for an amount of data smaller than a cache line, the completer interface may return a whole cache line comprising the requested content. In this way, all content retrieved from the completer device and returned to the requestor interface from the completer interface is of the predefined size. It will be readily apparent to the person of ordinary skill in the art that the example of a cache line size is provided for exemplary purpose only and that the predefined size may be any number of bits or bytes.

In some configurations the plurality of requests comprises a first request of a further type for first content specified in a sequentially first one of the plurality of ordered requests, wherein the completer interface is responsive to the first request to retrieve the first content and to return the first content to the requestor interface via the transport layer without waiting for a content return request. The requests include a further type of request for first content. The completer interface is responsive to requests of the further type to retrieve the first content and to return that content to the requestor device, i.e., without waiting for a content return request. The requestor interface is configured to respond to the plurality of ordered requests specifying content to be retrieved in the prescribed order, to issue a first request of the further type to retrieve content specified in the sequentially first one of the plurality of ordered requests, i.e., the request that, according to the prescribed order, is to be retrieved first. The requestor interface then issues each of the remaining requests in the plurality of ordered requests (i.e., requests 2 through to N for N ordered requests, where N is an integer greater than one) as a deferred-return request. The requestor interface can then control the order and timing at which the deferred-return requests are issued to enforce order without requiring additional storage to be added at the requestor interface.

In some configurations the requestor interface comprises buffer circuitry configured to temporarily store content returned from the completer interface; the requestor interface is responsive to receipt of a given request of the plurality of ordered requests to determine whether the buffer circuitry has available capacity to store given content specified in the given request; and when the buffer circuitry has the available capacity, to issue a content request of the further type specifying the given content, and in response to receipt of the given content, to store the given content in the buffer circuitry until content identified in preceding requests of the plurality of ordered requests has been returned. The buffer circuitry may comprise a single buffer to store content in response to a single request, or multiple buffers to store returned content for multiple requests. Rather than providing sufficient buffer storage for a total number of possible outstanding requests, the buffer storage may only be sufficient for a subset of potential outstanding transactions, e.g., the requestor interface may be able to support a large number of outstanding transactions with buffer storage circuitry being provided for a proper subset of the total number of outstanding transactions. When the requestor interface receives a new request, if there is space available in the buffer circuitry, then the request can be sent to the completer interface using a request of the further type, i.e., a request for the content to be returned without waiting for a content return request. The further request can be transmitted once acknowledgements have been received from the completer interface for previous transactions that must be ordered. In the event that there is insufficient buffer storage space, then the requestor interface can instead send a deferred-return request. This combination of features enables requests of the further type to be used where there is available storage space in the buffer circuitry reducing the latency of those requests and providing improved performance when there is low request traffic. The buffers in provided at the requestor interface can be used to reorder the returned content so that the content is returned in the request order. However, because buffers are not required for all possible outstanding transactions, the total buffer storage that is provided can be reduced resulting in a reduced circuit footprint. Where storage space in the buffer circuitry is not available, the requestor interface can switch to using deferred return requests when the request traffic is higher, resulting in higher throughput without needing larger buffers. In some configurations the requestor interface pre-allocates a space within the buffer circuitry to the content request prior to issuing the content request to the completer interface.

Particular configurations will now be described with reference to the figures.

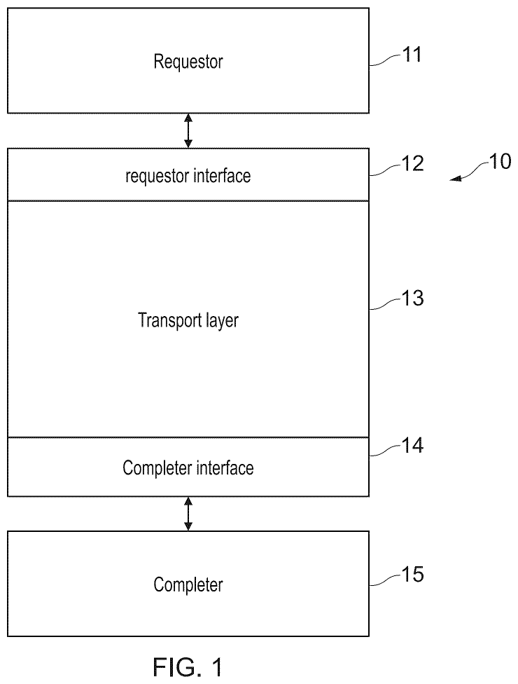

FIG. 1 schematically illustrates an apparatus 10 according to some configurations of the present techniques. The apparatus 10 is provided with a requestor interface 12, a transport layer 13 and a completer interface 14. The requestor interface 12 is configured to be coupled to a requestor device 11. The completer interface 14 is configured to be coupled to a completer device 15. The requestor device 11 may issue requests to the requester interface 12 for content to be retrieved. The requests may comprise a plurality of requests that need to be serviced in a prescribed order, e.g., the order in which they are issued by the requestor device 11.

The transport layer 13 is configured to transfer requests and content between the requestor interface 12 and the completer interface 14. The transport layer 13 is arranged to transfer data according to a transport protocol. The transport protocol enables transfer of content to be completed in an order other than an order in which the transfer of content was requested. Both requests and content transferred between the requestor interface 12 and the completer interface 14 are transferred through the transport layer 13.

The requestor interface 12 is responsive to receipt, from the requestor device 11, of a plurality of ordered requests that specify content to be retrieved in a prescribed order, to issue a plurality of requests to the completer layer 14 via the transport layer 13. The plurality of requests comprises one or more deferred-return requests to request the sequentially first content specified in the plurality of requests.

The completer interface 14 is responsive to a deferred-return request to retrieve corresponding content specified in that request, e.g., from storage circuitry accessible to the completer interface 14 or from the completer device 15, and to defer returning the corresponding content to the requestor device 12 until a return data request specifying the corresponding content is received from the requestor interface 12.

In some configurations the completer interface 14 is also responsive to a request of a further type to retrieve content specified in the request of the further type, e.g., from storage circuitry accessible to the completer interface 14 or from the completer device 15, and to return the content to the requestor device 12 via the transport layer 13, i.e., without waiting for a return data request in relation to the content specified in the request of the further type.

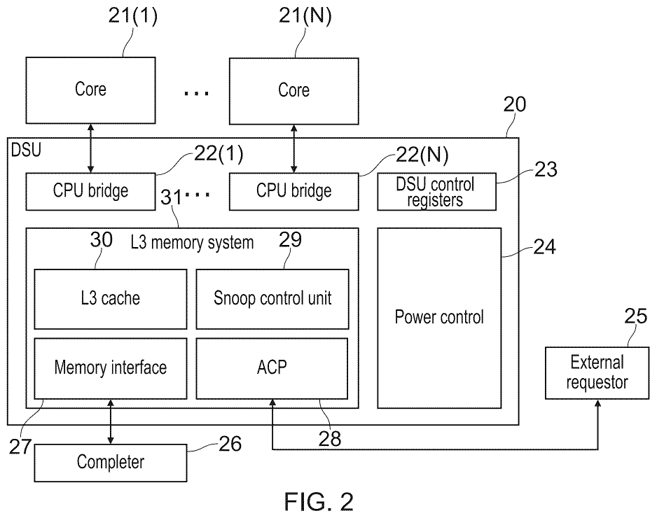

FIG. 2 schematically illustrates further detail of an apparatus 20 according to some configurations of the present techniques. In the illustrated configuration the apparatus 20 is a DynamIQ Shared Unit (DSU) which comprises the L3 memory system 31, CPU bridges 22, DSU control registers 23, and a power control unit 24. Each of the CPU bridges 21 is arranged to couple the DSU 20 to a processing core 21 and controls buffering and synchronisation between the processing core 21 and the DSU 20. The processing cores may be integrated with the DSU 20 as part of a DynamIQ cluster.

The DSU 20 implements a set of control registers 23 which are common to all of the cores 21 in the cluster and can be accessed from any of the cores 21 in the cluster. The registers 23 provide control for different aspects of the DSU. For example, the registers 23 may provide control for power management, L3 cache partitioning, quality of service controls and identifier assignment for the CHI protocol implemented as the transport protocol. It will be readily apparent to the person of ordinary skill in the art that one or more additional registers may be provided in addition to those explicitly mentioned here. The power control circuitry 24 may support a plurality of power modes that are controlled by an external power controller (not illustrated). The modes can be selected through power-mode requests from each of the cores 21 and may be controlled with reference to the DSU control registers 23.

The L3 memory system 31 is a shared memory system that is accessible to each of the cores 21. The L3 memory system 31 comprises an L3 cache storage 30 configured to store content to be accessed by each of the cores 21. The L3 cache 30 may be implemented in a variety of different sizes and may be implemented as a set associative cache or an indexed cache. The L3 memory system 31 further comprises a snoop control unit 29 configured to maintain coherency between all the data caches in the cluster, for example the L3 cache 30 and any L2 or L1 caches provided within the processing cores 21. The L3 memory system 31 further comprises a memory interface 27 configured to operate as a completer interface to enable the DSU 20 to be coupled to a completer device 26 which may be a main memory. The L3 memory system is responsive to receipt of requests from the cores 21 (which in some configurations are an example of a requestor device) to determine whether requested content is available in one or more of the L3 cache 30 and, via the snoop control unit 29, one or more caches associated with another core 21. If the request cannot be serviced by the L3 memory system 31, the L3 memory system 31 issues a request to retrieve the content from the completer device 26.

The L3 memory system further comprises an Accelerator Coherency Port (ACP) 28 which is configured as a requestor interface to be coupled to an external requestor device 25. The ACP 28 provides direct memory access to cacheable memory, for example, the L3 cache 30 and, via the snoop control unit, one or more caches provided by the cores 21. The snoop control unit 29 further maintains coherency for content requests received from the ACP 28. The ACP 28 operates according to the ACE-Lite protocol which may require a plurality of requests to be serviced according to a prescribed order, e.g., the order in which the requests are received by the ACP 28. Requests and content transferred between the ACP and the completer interface 27 are transferred via a transport layer (not explicitly illustrated). As described above, the transport layer is configured to enable content to be transferred such that the content is returned in an order other than the requested order. For example, the transport layer can facilitate the content being returned as soon as it is available.

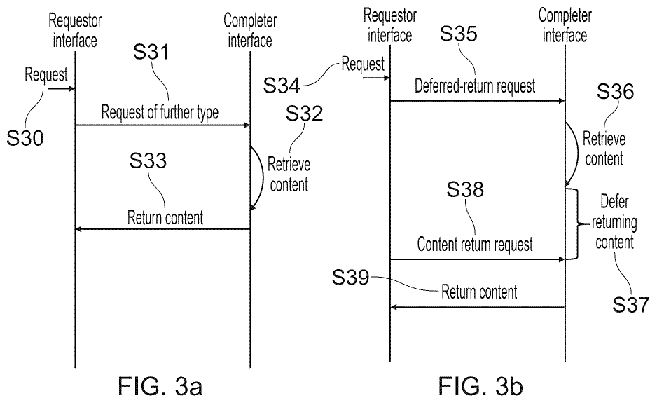

In order to maintain the prescribed ordering, e.g., as required by the ACE-Lite protocol, the requestor interface (e.g., the ACP 28) is capable of issuing deferred-return requests and requests of a further type. These requests are illustrated schematically in FIGS. 3a and 3b.

FIG. 3a schematically illustrates a request of the further type. The process begins at step S30 where a request for content is received at the requestor interface. At step S31 the requestor interface issues a request of the further type to the completer interface via the transport layer. The completer interface receives the request and, at step S32, retrieves the content specified in the request. The content may be retrieved from the L3 cache 30, a cache associated with one of the cores 21 (e.g., facilitated by the snoop control unit 29), or from a completer device coupled to the completer interface. Once the content is retrieved, in step S33 the content is returned to the requestor device, i.e., the completer interface does not wait for further signals or requests from the requestor interface.

FIG. 3b schematically illustrates a deferred-return request. The process begins at step S34 where a request for content is received at the requestor interface. At step S35 the requestor interface issues a deferred-return request to the completer interface via the transport layer. The completer interface receives the deferred-return request and, at step S36, retrieves the content specified in the request. The content may be retrieved from the L3 cache 30, a cache associated with one of the cores 21 (e.g., facilitated by the snoop control unit 29), or from a completer device coupled to the completer interface. Because the request is a deferred-return request, in step S37 the completer interface defers returning the content to the requestor interface. For example, the content may be stored in the L3 cache 30 pending a request to return the content. Subsequently, at step S38 the requestor interface issues a content return request specifying the content. Once the completer interface has received the request to return the content, at step S39 the completer interface returns the content to the requestor interface.

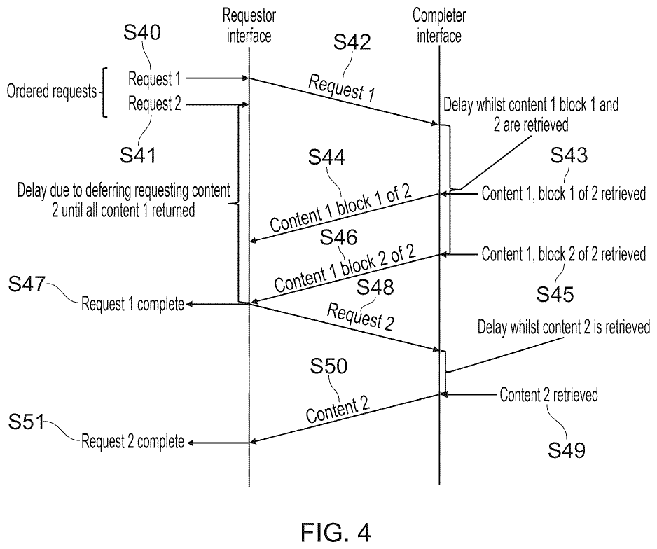

FIG. 4 schematically illustrates a method that could theoretically be used to enforce ordering across the transport layer without using deferred-return requests. The method is presented as a comparative example. In the comparative example, a first ordered request is received at step S40. Subsequently a second ordered request is received at step S42. The first and second ordered requests are a plurality of ordered requests that are to be handled in the prescribed order in which they are received, i.e., content specified in the first request should be returned before content specified in the second request. In response to receipt of the first request, the requestor interface, at step S42, issues a request to the completer interface. The completer interface receives the request and proceeds to retrieve the content specified in the first request. The specified content comprises two blocks of data (block 1 and block 2). Each of these blocks is retrieved and returned separately. In step S43 the first block of content is retrieved and is transferred to the requestor interface in step S44. In step S45 the second block of content is retrieved and is transferred to the requestor in step S46. At this stage, the content has been received in its entirety by the requestor interface and at step S47 the content is returned to the requestor device.

Subsequent to the first request being completed, at step S48 a second request is issued by the requestor interface to the completer interface for content specified in the second request. The completer interface is responsive to receipt of the second request and, proceeds to retrieve the content specified in the second request. In step S49 the content is retrieved and is transferred to the requestor interface in step S50. At this stage, the content has been received in its entirety by the requestor interface and at step S51 the content is returned to the requestor device.

Whilst this approach enables the content to be returned in order, because the second request is not handled until the first request has been completed, the delays associated with retrieval of each of the content blocks are experienced sequentially without overlap such that the total latency experienced is at least the sum of the latencies associated with retrieving the content specified in each of the requests.

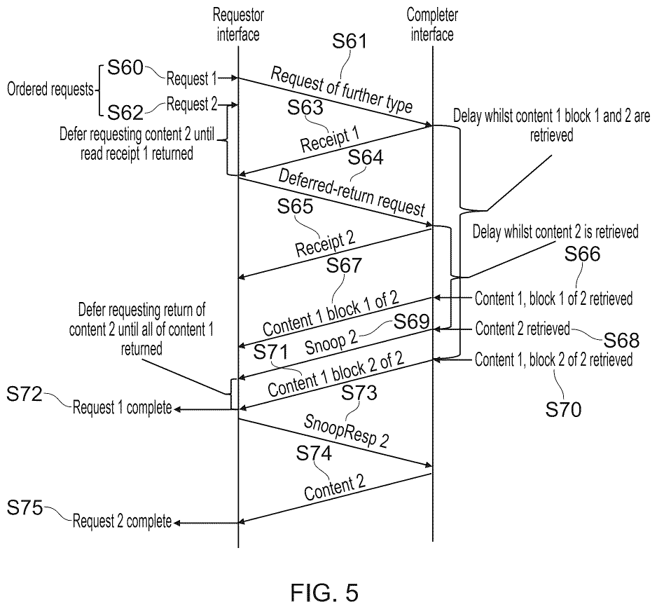

FIG. 5 schematically illustrates a sequence of interactions between a requestor interface and a completer interface according to some configurations of the present techniques. In the illustrated example, a first ordered request is received at step S60. Subsequently a second ordered request is received at step S62. The first and second ordered requests are a plurality of ordered requests specifying a same identifier, e.g., a same AXI identifier, indicating that the first and second request are to be handled in the prescribed order in which they are received, i.e., content specified in the first request should be returned before content specified in the second request. At step S61 the requestor identifies that the first request is the sequentially first request of the plurality of requests and issues a request of the further type to the completer interface. The issued request of the further type comprises an order indicator indicating that the request is to be serviced in order at the completer interface. The completer interface receives the request of the further type. The completer interface identifies that the request of the further type comprises the order indicator and, at step S63 returns a receipt to the requestor interface. In some configurations the order indicator comprises the same identifier to be used to communicate that the requests are requests of the same type to the completer interface.

After issuing the request of the further type, the requestor interface awaits a receipt from the completer interface. This ensures that there is no possibility of a subsequent request issued by the requestor interface being received and serviced by the completer interface before the request of the first type. When the requestor interface receives the receipt, at step S64, the requestor interface issues a deferred-return request to the completer interface. The deferred return request specifies the order indicator to indicate to the completer interface that the deferred return request is to be completed in order. The completer interface receives the deferred-return request. The completer interface identifies that the request of the deferred-return type comprises the order indicator and, at step S65, issues a receipt back to the requestor interface. As there is no third request, the requestor interface does not issue any further requests. The requestor interface may track the receipt so that a second deferred-return request could be issued, e.g., in response to receipt of a third request specifying a same identifier as the first and second request.

In parallel to issuing the receipt for the request of the further type at step S63, the completer interface proceeds to trigger retrieval of the content specified in the request of the further type. In addition, once the deferred-return request is received at step S64, the completer interface proceeds to trigger retrieval of the content specified in the deferred-return request. The retrieval of the content specified in each of the requests can therefore proceed in parallel with the content being returned to the completer interface in the order in which it is retrieved (which in some examples may differ from the order in which it is requested). At step S66 a first block of content associated with the request of the further type is retrieved. The first block of content is returned to the requestor interface at step S67. At step S68 the content specified in the deferred-return request is retrieved and, at step S69, the completer interface issues a snoop request to the requestor device indicating that the content has been retrieved and is ready to be transferred to the requestor interface. The snoop request does not include the content itself. At step S70 the second block of content associated with the request of the further type is retrieved. The second block of content is returned to the requestor interface in step S71.

The requestor interface therefore receives the first block of content associated with the first request (step S67), then the snoop request associated with the second content request (step S69), and the second block of content associated with the second request (step S71). Once both the first block and the second block of content are received by the requestor interface, the requestor interface determines that request 1 is complete and, at step S72, returns the content specified in the first request to the requestor device. Because the first request is now complete, i.e., all the content has been returned, and because a snoop request associated with the second request has been received, at step S73 the requestor interface issues a snoop response to indicate it is ready to receive the content. At step S74 the content associated with the second request is returned to the requestor interface and, at step S75, the second request is complete and the content can be returned to the requestor device.

This approach enables the content to be returned in order, because the second content is not returned until the first request has been completed. However, unlike the comparative example illustrated in FIG. 4, the latency associated with retrieving the content associated with the first request and the latency associated with retrieving the content associated with the second request are not experienced sequentially but can occur entirely or partially in parallel. As a result, the total latency associated with retrieval of each of the content blocks in FIG. 5 is less than the sum of the latencies associated with retrieving the content specified in each of the requests. Hence, the provision and use of the second request type results in a reduced latency. It will be readily apparent to the person of ordinary skill in the art that in some configurations the request of the further type, issued at step S61, could be replaced with a deferred-return request. In such a configuration, the requestor interface would track that this request is a sequentially first request and, hence, there is not a requirement to wait for any content associated with a sequentially preceding request before issuing a snoop response.

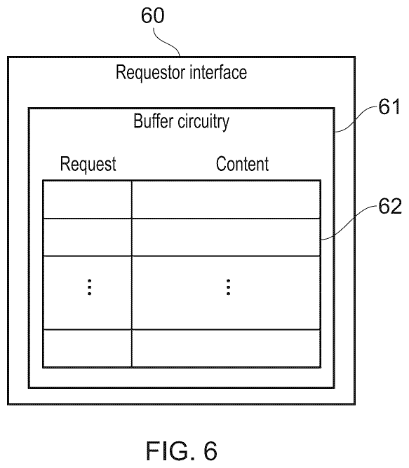

FIG. 6 schematically illustrates a requestor interface 60 according to some configurations of the present techniques. The requestor interface 60 is provided with buffer circuitry 61. The buffer circuitry is provided to temporarily store content returned from the completer interface. The buffer circuitry 61 comprises a plurality of buffers 62. The plurality of buffers 62 comprises fewer buffers than a total number of potential outstanding requests that the requestor interface 60 is able to issue to the completer interface before the requestor interface triggers the requestor to stall. The requestor interface 60 is responsive to receipt of a request of a plurality of ordered requests to determine if the buffer circuitry 61 has available space to store content identified in the request. If the buffer circuitry 61 comprises sufficient buffers 62 to store the content specified in the request, then the requestor interface 60 issues a request of the further type to the completer interface to trigger the completer interface to return the content without waiting for a content return request. The request of the further type is issued in order. The returned content may be received out of order (e.g., due to the transport layer) and is stored in the buffer circuitry 61 to be re-ordered prior to being returned to the requestor. If the buffer circuitry 61 does not comprise sufficient space, then the requestor interface 60 issues the request for content as a deferred-return request to the completer interface. The deferred-return request is issued in order and the subsequent content return request is issued in order once all subsequent data has been received by the requestor interface. The provision of the buffer circuitry enables requestor interface 60 to make use of the requests of the further type when buffer storage 62 is available (e.g., during instances of low request traffic) and to make use of the deferred-return requests otherwise (e.g., during instances of high request traffic). This approach provides a balance between lower latency associated with requests of the further type and the reduced requirement for buffer circuitry associated with the deferred-return request.

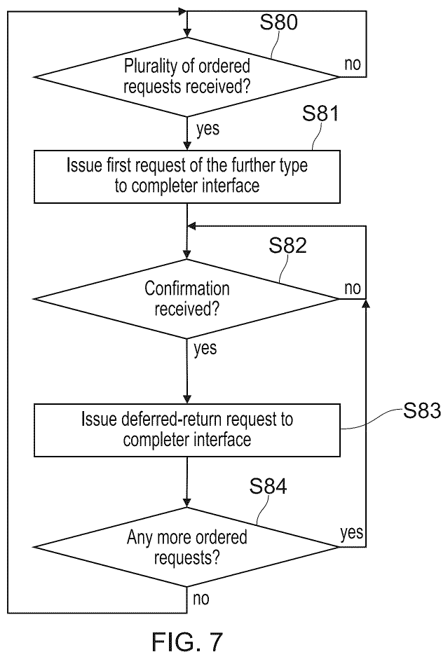

FIG. 7 schematically illustrates a sequence of steps carried out by a requestor interface according to some configurations of the present techniques. Flow begins at step S80 where it is determined whether a plurality of ordered requests have been received. If, at step S80, it is determined that a plurality of ordered requests have not been received, then flow remains at step S80. If, at step S80, it is determined that a plurality of ordered requests have been received, then flow proceeds to step S81. At step S81, the requestor interface issues a first request of the further type to the completer interface specifying content associated with the first one of the plurality of ordered requests. Flow then proceeds to step S82 where it is determined if a confirmation that the previously issued request has been received from the completer interface. If, at step S82, it is determined that confirmation has not been received, then flow remains at step S82. If, at step S82, it is determined that confirmation has been received, then flow proceeds to step S83 where a deferred-return request is issued to the completer interface specifying content associated with a sequentially next one of the plurality of ordered requests. Flow then proceeds to step S84 where it is determined if there are any more requests. If, at step S84, it is determined that there are not any more requests, then flow returns to step S80. If, at step S84, it is determined that there are more requests, then flow returns to step S82.

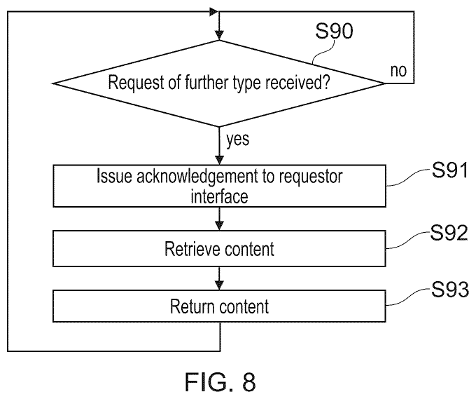

FIG. 8 schematically illustrates a sequence of steps carried out by a completer interface in response to a request of the further type according to some configurations of the present techniques. Flow begins at step S90 where it is determined if a request of the further type has been received. If, at step S90, it is determined that a request of the further type has not been received, then flow remains at step S90. If, at step S90, it is determined that a request of the further type has been received, then flow proceeds to step S91 where an acknowledgement is issued to the requestor interface. Flow then proceeds to step S92 where content specified in the request is retrieved. Flow then proceeds to step S93 where the content is returned to the requestor interface. Flow then returns to step S90.

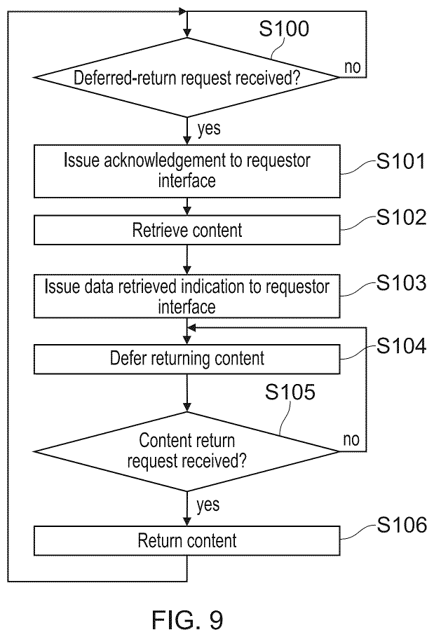

FIG. 9 schematically illustrates a sequence of steps carried out by a completer interface in response to a deferred-return request according to some configurations of the present techniques. Flow begins at step S100 where it is determined if a deferred-return request has been received. If, at step S100, it is determined that a deferred-return request has not been received, then flow remains at step S100. If, at step S100, it is determined that a deferred-return request has been received, then flow proceeds to step S101 where an acknowledgement is issued to the requestor interface. Flow then proceeds to step S102 where the content specified in the deferred-return request is retrieved. Flow then proceeds to step S103 where a data retrieved indication (e.g., a snoop request) is issued to the requestor interface. Flow then proceeds to step S104 where the completer interface defers returning the received content. Flow then proceeds to step S105 where it is determined if a content return request specifying the content retrieved in response to the deferred-return request has been received. If, at step S105, it is determined that no content return request has been received, then flow returns to step S104. If, at step S105, it is determined that a content return request has been received, then flow proceeds to step S106 where the content is returned before flow returns to step S100.

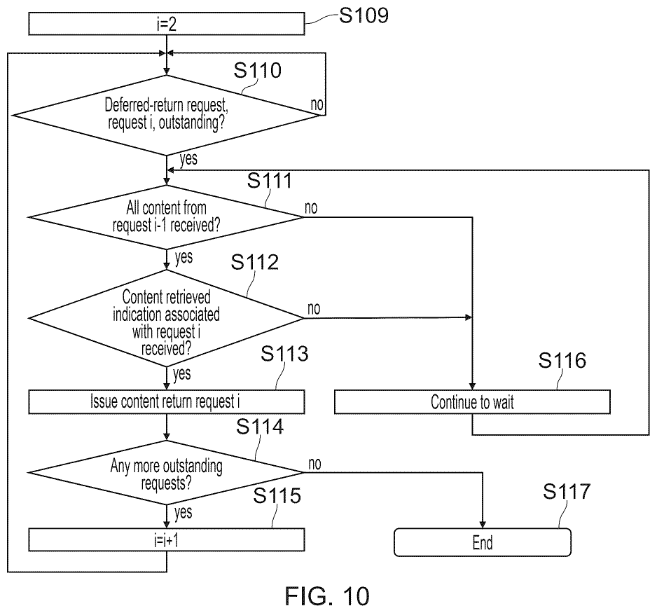

FIG. 10 schematically illustrates a set of steps carried out by a requestor interface to request content return for deferred-return requests issued in relation to a plurality of ordered requests according to some configurations of the present techniques. Flow begins at step S109 where variable i is set to 2. Flow then proceeds to step S110 where it is determined if request i is outstanding. If, at step S110 it is determined that there no outstanding request i, then flow remains at step S110. If, at step S110, it is determined that there is an outstanding deferred-return request, then flow proceeds to step S111. At step S111 it is determined if all content from a previous request (either a request of the further type or a deferred-return request), i.e., request i−1,has been received by the requestor interface. If, at step S111, it is determined that all content for request i−1 has been received, then flow proceeds to step S112. At step S112 it is determined if a content retrieved indication associated with a request i has been received. If, at step S112, it is determined that the content retrieved indication has been received, then flow proceeds to step S113 where a content return request specifying the content for request i is issued. Flow then proceeds to step S114 where it is determined if there are any more outstanding requests associated with the plurality of ordered requests. If, at step S114, it is determined that there are outstanding requests then flow proceeds to step S115 where i is incremented before flow returns to step S110. If, at step S115, it is determined that there are no more outstanding requests, then flow ends at step S117. If, at step S112, it was determined that the content retrieved indication associated with request i was not received, then flow proceeds to step S116 where the requestor interface continues to wait before flow returns to step S111. If, at step S111, it is determined that there is still outstanding content associated with request i−1, then flow proceeds to step S116 where the requestor interface continues to wait before flow returns to step S111.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

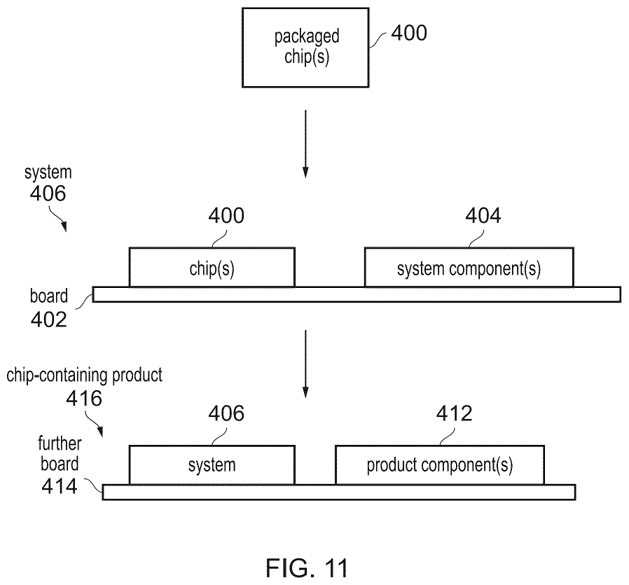

As shown in FIG. 11, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising a requestor interface to couple a requestor device to the apparatus, and a completer interface to couple the apparatus to a completer device. The apparatus is provided with a transport layer to transfer content between the requestor interface and the completer interface according to a protocol that enables the transfer of content to be completed in a completion order other than a request order. The requestor interface is responsive to receipt of a plurality of ordered requests specifying content to be retrieved in a prescribed order, to issue a plurality of requests to the completer interface, the plurality of requests comprising one or more deferred-return requests for content. The completer interface is responsive to a deferred-return request to retrieve the content and to defer returning the content until a content return request specifying the content is received.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
a requestor interface configured to couple a requestor device to the apparatus;
a completer interface configured to couple the apparatus to a completer device;
a transport layer configured to transfer content between the requestor interface and the completer interface according to a transport protocol that enables the transfer of content to be completed in a completion order other than a request order in which the transfer of content was requested,
wherein the requestor interface is responsive to receipt of a plurality of ordered requests specifying content to be retrieved in a prescribed order, to issue a plurality of requests to the completer interface via the transport layer, the plurality of requests comprising one or more deferred-return requests for corresponding content specified in the plurality of ordered requests, wherein the completer interface is responsive to a deferred-return request of the one or more deferred-return requests to retrieve the corresponding content specified in the deferred-return request and to defer returning the corresponding content to the requestor interface until a corresponding content return request specifying the corresponding content is received from the requestor interface.
   Clause 2. The apparatus of clause 1, wherein the requestor interface is configured to defer issuing the corresponding content return request until all content associated with a sequentially preceding request has been received at the requestor interface.
   Clause 3. The apparatus of clause 2, wherein:
the completer interface is responsive to receipt of each of the plurality of requests to issue an acknowledgement to the requestor interface via the transport layer; and
the requestor interface is configured to defer issuing the deferred-return request until receipt of the acknowledgement for the sequentially preceding request.
   Clause 4. The apparatus of clause 2 or clause 3, wherein:
the completer interface is configured to issue a data retrieved indication to the requestor interface once the corresponding content has been retrieved; and
the requestor interface is configured to defer issuing the content return request until the data retrieved indication is received.
   Clause 5. The apparatus of any preceding clause, comprising storage circuitry accessible to the completer interface and configured to store the corresponding content retrieved in response to the deferred-return request.
   Clause 6. The apparatus of clause 5, wherein the storage circuitry is a cache.
   Clause 7. The apparatus of clause 5 or clause 6, wherein the completer interface is configured to retrieve the corresponding content by performing a lookup in the storage circuitry.
   Clause 8. The apparatus of clause 7, wherein the completer interface is responsive to the lookup resulting in a miss in the storage circuitry, to forward the deferred-return request to a further storage structure.
   Clause 9. The apparatus of any preceding clause, wherein content transfer between the requestor device and the requestor interface is performed according to a first content transfer protocol different from the transport protocol.
   Clause 10. The apparatus of clause 9, wherein the first content transfer protocol enforces ordering between at least some requests.
   Clause 11. The apparatus of clause 9 or clause 10, wherein content transfer between the completer and the completer interface is performed according to a second content transfer protocol different from the first content transfer protocol.
   Clause 12. The apparatus of clause 11, wherein the second content transfer protocol allows at least some requests to be completed out of order with respect to an order in which the requests were received.
   Clause 13. The apparatus of clause 11 or clause 12, wherein the second content transfer protocol enforces ordering between requests identified with a same identifier.
   Clause 14. The apparatus of any preceding clause, wherein:
the requestor interface is configured to issue each of the plurality of requests specifying an order indicator; and
the completer interface is responsive to the plurality of requests specifying the order indicator to enforce ordering between the plurality of requests.

Clause 15. The apparatus of any preceding clause, wherein the requestor interface is responsive to receipt of a plurality of requests specifying content to be retrieved to determine whether the plurality of requests is to be retrieved in the prescribed order in dependence on whether the plurality of requests specify a same identifier.

Clause 16. The apparatus of any preceding clause, wherein:
the requestor interface comprises request tracking circuitry to track a plurality of outstanding requests; and
the requestor interface is responsive to an indication that a number of outstanding requests exceeds a predefined limit, to trigger the requestor to stall incoming requests.
   Clause 17. The apparatus of any preceding clause, wherein the completer interface is responsive to given content associated with a given one of the plurality of ordered requests exceeding a predefined size, to return the content as a plurality of content blocks of the predefined size.
   Clause 18. The apparatus of any preceding clause, wherein the plurality of requests comprises a first request of a further type for first content specified in a sequentially first one of the plurality of ordered requests, wherein the completer interface is responsive to the first request to retrieve the first content and to return the first content to the requestor interface via the transport layer without waiting for a content return request.
   Clause 19. The apparatus of clause 18, wherein:
the requestor interface comprises buffer circuitry configured to temporarily store content returned from the completer interface;
the requestor interface is responsive to receipt of a given request of the plurality of ordered requests to determine whether the buffer circuitry has available capacity to store given content specified in the given request; and
when the buffer circuitry has the available capacity, to issue a content request of the further type specifying the given content, and in response to receipt of the given content, to store the given content in the buffer circuitry until content identified in preceding requests of the plurality of ordered requests has been returned.
   Clause 20. A system comprising:
the apparatus of any preceding clause, implemented in at least one packaged chip;
at least one system component; and
a board,
wherein the at least one packaged chip and the at least one system component are assembled on the board.
   Clause 21. A chip-containing product comprising the system of clause 20, wherein the system is assembled on a further board with at least one other product component.
   Clause 22. A method of operating an apparatus comprising a requestor interface configured to couple a requestor device to the apparatus, and a completer interface configured to couple the apparatus to a completer device, the method comprising:
with a transport layer, transferring content between the requestor interface and the completer interface according to a transport protocol that enables the transfer of content to be completed in a completion order other than a request order in which the transfer of content was requested,
in response to receipt, at the requestor interface, of a plurality of ordered requests specifying content to be retrieved in a prescribed order, issuing a plurality of requests to the completer interface via the transport layer, the plurality of requests comprising one or more deferred-return requests for corresponding content specified in the plurality of ordered requests;
   in response to a deferred-return request of the one or more deferred-return requests, with the completer interface, retrieving the corresponding content specified in the subsequent request and deferring returning the corresponding content to the requestor interface until a content return request specifying the corresponding content is received from the requestor interface.
   Clause 23. A non-transitory computer-readable medium storing computer-readable code for fabrication of the apparatus of any of clauses 1 to 19.

We claim:

1. An apparatus comprising:
a requestor interface configured to couple a requestor device to the apparatus;
a completer interface configured to couple the apparatus to a completer device;
a transport layer configured to transfer content between the requestor interface and the completer interface according to a transport protocol that enables the transfer of content to be completed in a completion order other than a request order in which the transfer of content was requested,
wherein the requestor interface is responsive to receipt of a plurality of ordered requests specifying content to be retrieved in a prescribed order, to issue a plurality of requests to the completer interface via the transport layer, the plurality of requests comprising one or more deferred-return requests for corresponding content specified in the plurality of ordered requests, wherein the completer interface is responsive to a deferred-return request of the one or more deferred-return requests to retrieve the corresponding content specified in the deferred-return request and to defer returning the corresponding content to the requestor interface until a corresponding content return request specifying the corresponding content is received from the requestor interface.

2. The apparatus of claim 1, wherein the requestor interface is configured to defer issuing the corresponding content return request until all content associated with a sequentially preceding request has been received at the requestor interface.

3. The apparatus of claim 2, wherein:
the completer interface is responsive to receipt of each of the plurality of requests to issue an acknowledgement to the requestor interface via the transport layer; and
the requestor interface is configured to defer issuing the deferred-return request until receipt of the acknowledgement for the sequentially preceding request.

4. The apparatus of claim 2, wherein:
the completer interface is configured to issue a data retrieved indication to the requestor interface once the corresponding content has been retrieved; and
the requestor interface is configured to defer issuing the content return request until the data retrieved indication is received.

5. The apparatus of claim 1, comprising storage circuitry accessible to the completer interface and configured to store the corresponding content retrieved in response to the deferred-return request.

6. The apparatus of claim 5, wherein the completer interface is configured to retrieve the corresponding content by performing a lookup in the storage circuitry.

7. The apparatus of claim 6, wherein the completer interface is responsive to the lookup resulting in a miss in the storage circuitry, to forward the deferred-return request to a further storage structure.

8. The apparatus of claim 1, wherein content transfer between the requestor device and the requestor interface is performed according to a first content transfer protocol different from the transport protocol.

9. The apparatus of claim 8, wherein the first content transfer protocol enforces ordering between at least some requests.

10. The apparatus of claim 10, wherein content transfer between the completer and the completer interface is performed according to a second content transfer protocol different from the first content transfer protocol.

11. The apparatus of claim 10, wherein at least one of:
the second content transfer protocol allows at least some requests to be completed out of order with respect to an order in which the requests were received; and
the second content transfer protocol enforces ordering between requests identified with a same identifier.

12. The apparatus of claim 1, wherein:
the requestor interface is configured to issue each of the plurality of requests specifying an order indicator; and
the completer interface is responsive to the plurality of requests specifying the order indicator to enforce ordering between the plurality of requests.

13. The apparatus of claim 1, wherein the requestor interface is responsive to receipt of a plurality of requests specifying content to be retrieved to determine whether the plurality of requests is to be retrieved in the prescribed order in dependence on whether the plurality of requests specify a same identifier.

14. The apparatus of claim 1, wherein:
the requestor interface comprises request tracking circuitry to track a plurality of outstanding requests; and
the requestor interface is responsive to an indication that a number of outstanding requests exceeds a predefined limit, to trigger the requestor to stall incoming requests.

15. The apparatus of claim 1, wherein the plurality of requests comprises a first request of a further type for first content specified in a sequentially first one of the plurality of ordered requests, wherein the completer interface is responsive to the first request to retrieve the first content and to return the first content to the requestor interface via the transport layer without waiting for a content return request.

16. The apparatus of claim 15, wherein:
the requestor interface comprises buffer circuitry configured to temporarily store content returned from the completer interface;
the requestor interface is responsive to receipt of a given request of the plurality of ordered requests to determine whether the buffer circuitry has available capacity to store given content specified in the given request; and
when the buffer circuitry has the available capacity, to issue a content request of the further type specifying the given content, and in response to receipt of the given content, to store the given content in the buffer circuitry until content identified in preceding requests of the plurality of ordered requests has been returned.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method of operating an apparatus comprising a requestor interface configured to couple a requestor device to the apparatus, and a completer interface configured to couple the apparatus to a completer device, the method comprising:
with a transport layer, transferring content between the requestor interface and the completer interface according to a transport protocol that enables the transfer of content to be completed in a completion order other than a request order in which the transfer of content was requested,
in response to receipt, at the requestor interface, of a plurality of ordered requests specifying content to be retrieved in a prescribed order, issuing a plurality of requests to the completer interface via the transport layer, the plurality of requests comprising one or more deferred-return requests for corresponding content specified in the plurality of ordered requests;
in response to a deferred-return request of the one or more deferred-return requests, with the completer interface, retrieving the corresponding content specified in the subsequent request and deferring returning the corresponding content to the requestor interface until a content return request specifying the corresponding content is received from the requestor interface.

20. A non-transitory computer-readable medium storing computer-readable code for fabrication of an apparatus comprising:
a requestor interface configured to couple a requestor device to the apparatus;
a completer interface configured to couple the apparatus to a completer device;
a transport layer configured to transfer content between the requestor interface and the completer interface according to a transport protocol that enables the transfer of content to be completed in a completion order other than a request order in which the transfer of content was requested,
wherein the requestor interface is responsive to receipt of a plurality of ordered requests specifying content to be retrieved in a prescribed order, to issue a plurality of requests to the completer interface via the transport layer, the plurality of requests comprising one or more deferred-return requests for corresponding content specified in the plurality of ordered requests, wherein the completer interface is responsive to a deferred-return request of the one or more deferred-return requests to retrieve the corresponding content specified in the deferred-return request and to defer returning the corresponding content to the requestor interface until a corresponding content return request specifying the corresponding content is received from the requestor interface.
